(19) United States
(12) Patent Application Publication
(10) Pub. No.: US 2018/0124634 A1
(43) Pub. Date: May 3, 2018

(54) LOGICAL CHANNEL PRIORITIZATION AND DATA BLOCK PREPARATION

(71) Applicant: MEDIATEK SINGAPORE PTE. LTD., Singapore (SG)

(72) Inventors: Pradeep JOSE, Swindon (GB); Mukesh CHOUHAN, Milton Keynes (GB); Cyril VALADON, Letchworth Garden City (GB)

(73) Assignee: MEDIATEK SINGAPORE PTE. LTD., Singapore (SG)

(21) Appl. No.: 15/793,350

(22) Filed: Oct. 25, 2017

Related U.S. Application Data
(60) Provisional application No. 62/436,485, filed on Dec. 20, 2016.
(60) Provisional application No. 62/414,031, filed on Oct. 28, 2016.

(51) Int. Cl. H04W 28/02; H04W 72/12; H04L 5/00; H04W 28/24

(52) U.S. Cl. CPC H04W 28/0268; H04W 72/1242; H04W 72/1268; H04W 28/24; H04L 5/0092; H04L 5/0064

(57) ABSTRACT

Aspects of the disclosure provide a method for data transmission prioritization in a communication device. The method can include receiving multiple streams of data units. Each stream of data units has a prioritized bit rate (PBR), a priority value, and a variable (Bj) representing a number of bits that are to be prioritized for transmission of data units of the respective stream. The method can further include allocating transmission resources to streams having a variable (Bj) larger than zero in an order based on the priority values for transmission of data units during a TTI up to a size of available data units in the respective stream, and allocating remaining transmission resources to streams having a variable Bj smaller than zero in an order based on the priority values for transmission data units during the TTI up to a size of available data units in the respective stream.

### INCORPORATION BY REFERENCE

This present disclosure claims the benefit of U.S. Provisional Application No. 62/436,485, “Method of Multiplexing Multiple Logical Channels According to Their Quality of Service into a Data Block” filed on Dec. 20, 2016, and U.S. Provisional Application No. U.S. 62/414,031, “Method of Data Block Preparation for Transmission Prior to Knowledge of Physical Layer Resource” filed on Oct. 28, 2016, which are incorporated herein by reference in their entirety.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

The logical channel prioritization (LCP) scheme defined in LTE communication standards takes a significant amount of time, and is performed after the transmission resource grant is known. With the 5th generation (5G) communication standards, for example, it is expected that the time available to perform LCP will reduce significantly and the existing algorithm cannot be easily completed in time.

### SUMMARY

Aspects of the disclosure provide a method for data transmission prioritization in a communication device. The method can include receiving multiple streams of data units. Each stream of data units has a prioritized bit rate (PBR) for maintaining a quality of service (QoS) level for the respective stream, a priority value, and a variable (Bj) representing a number of bits that are to be prioritized for transmission of data units of the respective stream. The variable (Bj) is incremented for each transmission time interval (TTI) at the respective PBR. The method can further include allocating transmission resources to streams having a variable (Bj) larger than zero in an order based on the priority values for transmission of data units during a TTI up to a size of available data units in the respective stream, or a size of available transmission resources, whichever is smaller, and allocating remaining transmission resources to streams having a variable Bj smaller than zero in an order based on the priority values for transmission data units during the TTI up to a size of available data units in the respective stream, or a size of available transmission resources, whichever is smaller.

In an embodiment, the method can further include decrementing the variable (Bj) of the respective stream having a variable (Bj) larger than zero by a size of transmission resources allocated to the respective stream. In an embodiment, each stream is received on a logical channel at a medium access control (MAC) layer of the communication device.

In an embodiment, the transmission resources correspond to available spaces in a data block to be transmitted during the TTI at the communication device. The method can further include filling data units into the data block according to transmission resource allocations to generate the data block, and processing and transmitting the generated data block.

In an embodiment, one of the streams is further configured with a negative limit for the respective variable (Bj), and the method can further include decrementing the variable (Bj) of the respective stream having a variable (Bj) larger than zero by a size of transmission resources allocated to the respective stream up to a minimum of the negative limit

Aspects of the disclosure provide a non-transitory computer readable medium having computer readable instructions stored thereon which, when executed by a processing circuit, cause the processing circuit to perform the method for data transmission prioritization.

Aspects of the disclosure provide a method for data block preparation prior to knowledge of transmission resources at a communication device. The method can include receiving streams of data units, preparing a first data block including data units for transmission in a transmission time interval (TTI) prior to knowledge of transmission resources granted for the TTI, receiving a grant of transmission resources for the TTI, determining a portion of the first data block to fit a second data block having a size determined according to the grant of transmission resources for the TTI, and processing and transmitting the second data block including the determined portion of the first data block.

In an embodiment, the method further includes transferring part or all of the first data block from an external memory to an on-chip memory prior to reception of the grant of transmission resources for the TTI. In an embodiment, the method further includes starting to process the first data block prior to reception of the grant of transmission resources for the TTI. In an embodiment, the method includes generating control information for the second data block after reception of the grant of transmission resources, the generated control information being included in the second data block.

In an embodiment, each stream of data units is configured with a priority bit rate (PBR) for maintaining a quality of service (QoS) level for the respective stream, and a priority value. The step of preparing the first data block can include filling a first section of the first data block with data units from each stream up to an amount determined by the PBR of each stream, and filling a second section of the first data block with the rest of data units of each stream in an order based on the priority values. The determined portion of the first data block to fit the second data block includes a part or all of the first section of the first data block.

Aspects of the disclosure provide a communication device. The communication device includes circuitry configured to implement the method for data block preparation prior to knowledge of transmission resources.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a communication device according to an embodiment of the disclosure;

FIG. 2 shows uplink data flows through multiple protocol layers in the communication device according to an embodiment of the disclosure;

FIG. 3 shows a conventional logical channel prioritization (LCP) process;

FIG. 4 shows a data transmission prioritization process according to an embodiment of the disclosure;

FIG. 5 shows an example LCP process according to an embodiment of the disclosure;

FIG. 6 shows another example LCP process according to an embodiment of the disclosure;

FIG. 7 shows a transmission resource grant timing example;

FIG. 8 shows a non-real time data block preparation example according to an embodiment of the disclosure;

FIGS. 9A-9B show examples of selecting a portion of a non-real time data block to fit a transport block size according to an embodiment of the disclosure;

FIG. 10 shows an example of a transport block according to an embodiment of the disclosure;

FIGS. 11A-11C shows examples of control information structures according to an embodiment of the disclosure;

FIG. 12 shows a data block preparation process according to an embodiment of the disclosure; and

FIG. 13 shows a communication device according to embodiments of the disclosure.

### DETAILED DESCRIPTION OF EMBODIMENTS

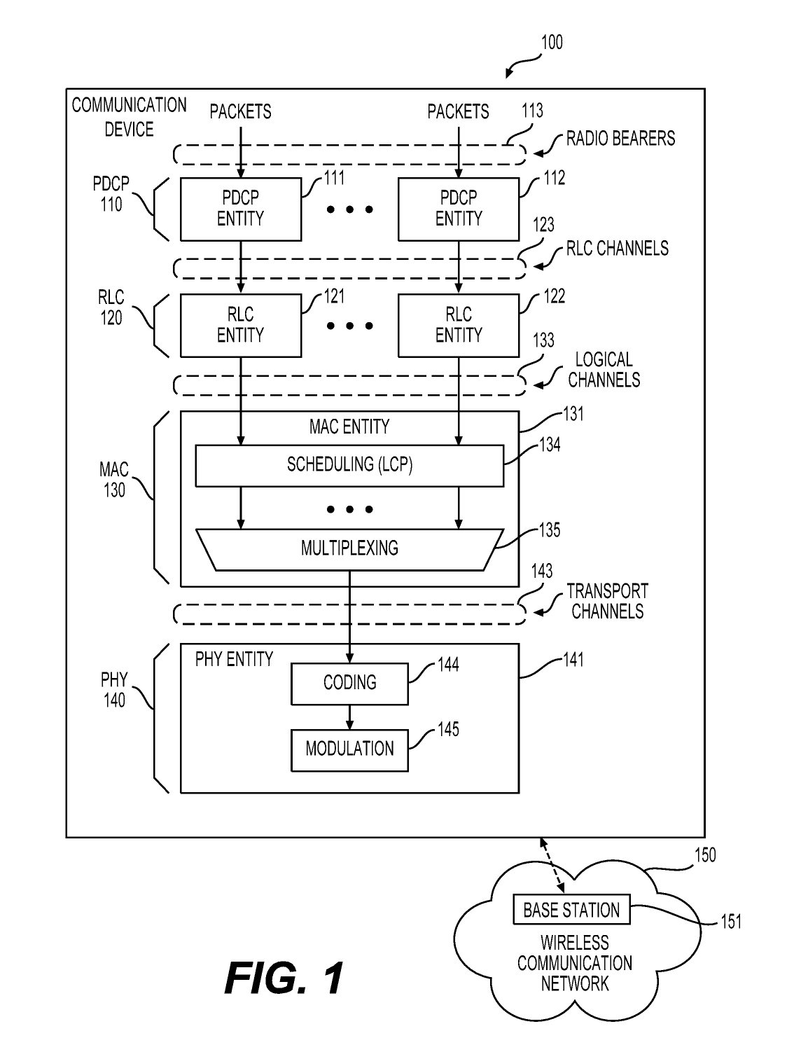

FIG. 1 shows a communication device 100 according to an embodiment of the disclosure. The communication device 100 can communicate with a base station 151 in a wireless communication network 150. For example, the wireless communication network 150 can be network compliant with wireless communication standards developed or being developed by the 3rd Generation Partnership Project (3GPP), such as the LTE standards, 5G New Radio (NR) standards, and the like. Alternatively, the wireless communication network 150 can be other types of communication networks compliant with other communication standards. The communication device 100 can be a portable device, such as a mobile phone, a tablet computer, a laptop computer, and the like. In other examples, the communication device 100 can be a non-portable communication device, such as a desktop computer, a vehicle-carried device, a communication device in a utility meter, and the like.

The communication device 100 includes multiple entities configured to perform functions of a radio protocol stack such that the communication device 100 can properly communicate with the wireless communication network 150 via a radio interface. As an example, entities corresponding to a subset of layers of the radio protocol stack are shown in FIG. 1. The subset of the layers includes a packet data convergence protocol (PDCP) layer 110, a radio link control (RLC) layer 120, a medium access control (MAC) layer 130, and a physical layer (PHY) 140. Each layer in the radio protocol stack can include functions for processing either downlink information received from the base station 151 or uplink information to-be-transmitted to the base station 151. In FIG. 1 example, entity functions for processing uplink information are presented.

The PDCP layer 110 provides services to upper layers of the protocol stack in the form of radio bearers 113. For example, packet flows carrying user information can be generated from different applications, such as voice, video, HTTP, FTP applications, while packet flows carrying control information can be generated from upper layers in a control plane of the protocol stack, such as a radio resource control (RRC) layer. Different packet flows can require difference quality of service (QoS) level, thus can be received on different radio bearers that are treated differently to satisfy the QoS requirements. Multiple PDCP entities 111-112 can be configured each corresponding to a radio bearer. In one example, each PDCP entity 111-112 performs IP header compression, and ciphering.

The RLC layer 120 provides services to the PDCP layer in the form of RLC channels 123. Similarly, multiple RLC entities 121-122 can be configured each corresponding to a radio bearer. In one example, each RLC entity 121-122 performs segmentation and concatenation on data units received from the PDCP layer 110 to form a payload. In another example, each RLC entity 121-122 does not perform concatenation on data units in order to reduce processing latency.

The MAC layer 130 provides services to the RLC layer 120 in the form of logical channels 133. Each logical channel 133 corresponds to a radio bearer. A MAC entity 131 can be configured to perform functions of scheduling 134 and multiplexing 135 to generate a data block, referred to as a transport block. In one example, the size of the transport block is determined according to a grant of transmission resources received from the base station 151. For example, data can be transferred periodically from the communication device 100 to the base station 151 over a sequence of transmission time intervals (TTIs). A grant of transmission resources can be determined for a TTI, for example, by a scheduler at the base station 151. The grant can specify physical transmission resources (e.g., time-frequency resources in an orthogonal frequency-division multiplexing (OFDM) system) assigned for the TTI, a modulation scheme for transmission during the TTI, and the like. Based on the grant, a size of a transport block corresponding to the TTI can be determined.

In scheduling 134, the MAC entity 131 allocates spaces in the transport block to logical channels 133 to satisfy QoS requirements of each logical channel. The allocation can be performed based on a set of rate control parameters and a logical channel prioritization (LCP) process. For example, a set of rate control parameters can be configured for each logical channel. The rate control parameters, for example, can be determined by the wireless communication network 150 and signaled to the RRC layer at the communication device 100. In one example, the rate control parameters of a logical channel include a priority value, and a prioritized bit rate (PBR). The PBR can specify a minimum bit rate required by a respective QoS level of the logical channel. Based on the rate control parameters of each logical channel, the LCP process can be performed to determine transmission resource allocations for each logical channel. For example, spaces in the transport block are allocated among the logical channels.

In multiplexing 135, the MAC entity 131 fills data units of the logical channels 133 into the transport block according to transmission resource allocations for each logical channel. In this way, data units from multiple logical channels can be multiplexed into one transmission of a TTI.

The PHY layer 140 provides services to the MAC layer 130 in the form of transport channels 143. A PHY entity 141 is configured to perform functions of coding 144 and modulation 145 in one example.

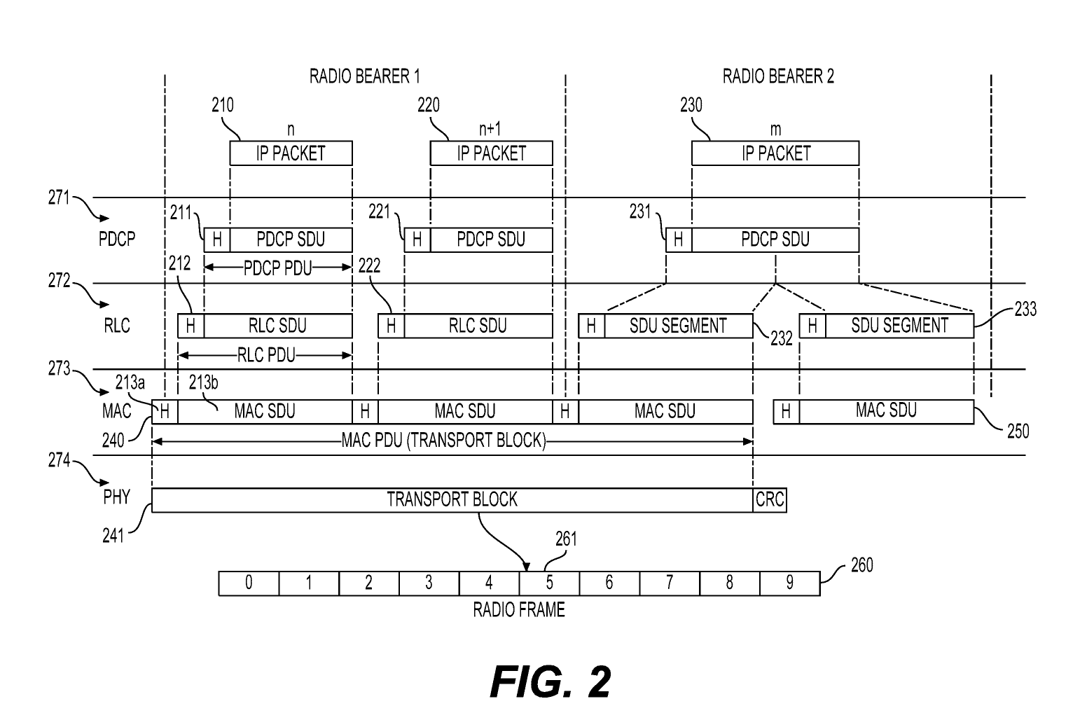

FIG. 2 shows uplink data flows through a PDCP layer 271, a RLC layer 272, a MAC layer 273, and a PHY layer 274 in the communication device 100 according to an embodiment of the disclosure. Three IP packets 210, 220, and 230 are shown in FIG. 2 example. The packets 210 and 220 are received on radio bearer 1, while the packet 230 is received on radio bearer 2. For the packet 210, the PDCP layer 271 performs IP-header compression and ciphering, and adds a header to the processed packet to form a PDCP PDU 211. The header can carry information useful for deciphering operation at the side of the wireless network 150. In general, data entity from/to a higher protocol layer is known as a service data unit (SDU) and corresponding entity to/from a lower protocol layer is called a protocol data unit (PDU).

Subsequently, the RLC layer 272 receives the PDCP PDU 211 as a RLC SDU. The RLC layer 272 adds a header to the RLC SDU to form an RLC PDU 212. The header can be used for in-sequence delivery per logical channel at the side of the wireless network 150, and for identification of RLC PDUs in the case of retransmissions. In alternative examples, the RLC layer 272 performs concatenation of PDCP PDUs to form one RLC PDU. The formed RLC PDU 212 is forwarded to the MAC layer 273. For the packet 220, similar processing can be performed at the PDCP and RLC layers 271-272 to form a RLC PDU 222 that is subsequently forwarded to the MAC layer 273.

For the packet 230 received on the radio bearer 2, processing similar to what is performed for bearer 1 can be carried out. However, a PDCP PDU 231 is segmented into two parts at the RLC layer 272, and two RLC PDU 232-233 are subsequently generated and forwarded to the MAC layer 273.

The MAC layer 273 multiplexes RLC PDUs from the two radio bearers, and attaches a MAC header to each multiplexed RLC PDU to form a transport block for a TTI. For example, a LCP process can first be performed to allocate spaces in a transport block 240 to two logical channels corresponding to radio bearer 1 and radio bearer 2. Based on the allocations to the two logical channels, the RLC PDUs 212 and 222 of radio bearer 1, and the RLC PDU 232 of radio bearer 2 are filled into the transport block 240. In one example, segmentation of the PDCP PDU 231 can be performed according to the allocations determined by the LCP process, such that the RLC PDU 232 can fit in an allocation. The remaining RLC PDU 233 can be processed together with other packets received later on radio bearers 1 and 2, and fitted into another transport block.

The PHY layer 274 receives the transport block 240 and attaches a cyclic redundancy check (CRC) block to the transport block 240 for error-detection purpose. A data block 241 can thus be formed. The PHY layer 274 can then perform coding and modulation to further process the data block 241. In one example, the processed data block 241 is carried by time-frequency resources in a sub-frame 261 of a radio frame 260. For example, the radio frame 260 has a structure specified by an LTE communication standard, and includes 10 sub-frames each corresponding to a TTI of 1 ms.

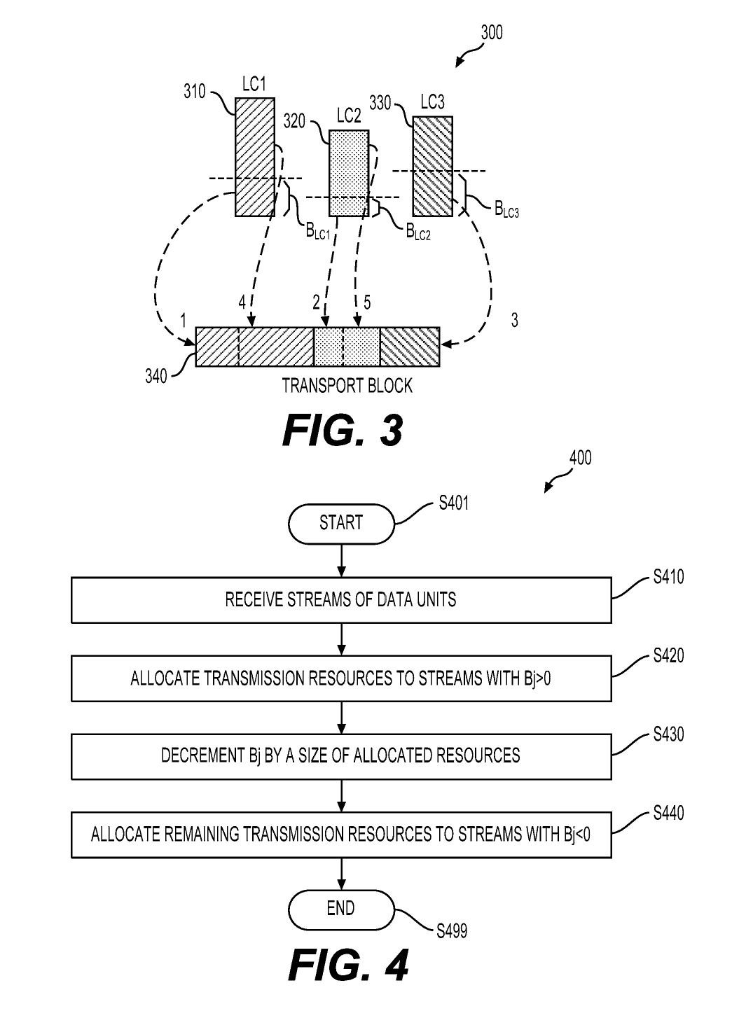

FIG. 3 shows a conventional LCP process 300. The process 300 can be performed at a MAC entity to allocate transmission resources for transmission of data units from multiple logical channels. The conventional LCP process 300 is based on a conventional LCP mechanism defined as follows. A set of rate control parameters can be configured for each logical channel. Specifically, each logical channel (LC) is configured with a PBR, a bucket size duration (BSD), and a priority value. Each logical channel j maintains a variable Bj, representing an available token size that is a number of bits that are to be prioritized for transmission of data units of the respective logical channel. The variable Bj is initialized to zero when the logical channel is established and is incremented by PBR×TTI duration for each TTI. If a value of the variable Bj is larger than a bucket size of the logical channel j, the variable Bj is set to the bucket size. The bucket size of the logical channel is equal to PBR×BSD.

The conventional LCP scheme can include the following three steps. At a first step, logical channel with Bj>0 are allocated resources in a decreasing priority order each up to a size of the respective Bj while avoiding segmentation of RLC PDUs. A decreasing priority order refers to an order that a logical channel with a higher priority is served before a logical channel with a lower priority. At a second step, the MAC entity decrements Bj by a total size of MAC SDUs served to the respective logical channel j in the first step. The value of Bj can be negative to prevent segmentation of RLC PDUs. At a third step, if any resources remain, all the logical channels are served in a strict decreasing priority order. The conventional LCP mechanism ensures that radio bearers or logical channels are served in the following sequence: all the radio bearers are served in decreasing priority order up to their PBR; and all the radio bearers are served in decreasing priority order for the remaining resources assigned by a grant.

In FIG. 3 example, spaces of a transport block 340 are to be assigned to three logical channels LC1, LC2, and LC3. The three logical channels LC1, LC2, and LC3 are presented in decreasing priority order from left to right. Blocks 310-330 represent available data units of the respective logical channels. Sizes of three available token size variables BLC1, BLC2, and BLC3 are marked on each block 310-330. During the conventional LCP process 300, each logical channel LC1, LC2, or LC3 is first served up to their available token size BLC1, BLC2, and BLC3 in decreasing priority order in steps 1-3 as shown in FIG. 3. Then, the variable BLC1, BLC2, and BLC3 can be decremented each by an amount of spaces assigned to the respective logical channel. Subsequently, the rest of data on the logical channels fill up the remaining spaces in the transport block 340 in steps 4 and 5.

FIG. 4 shows a data transmission prioritization process 400 according to an embodiment of the disclosure. The process 400 can be performed to allocate transmission resources to multiple streams of data units. The process 400 can be performed based on a set of preconfigured rate control parameters similarly defined in the FIG. 3 example. However, the process 400 is based on a prioritization scheme different from the FIG. 3 example. The process 400 starts at S401 and proceeds to S410.

At S410, streams of data units can be received, for example, on logical channels of a MAC layer. Each stream of data units can be configured with a prioritized bit rate (PBR), a priority value, and a variable Bj. The variable Bj represents a number of bits that are to be prioritized for transmission of data units of the respective stream and is incremented for each transmission time interval (TTI) at the respective PBR. The variable Bj can be set to zero when a respective logical channel is initialized.

At S420, transmission resources are allocated to streams having a variable Bj larger than zero in a decreasing priority order. The transmission resources can be spaces of a transport block for transmission data units during a TTI. A size of the transport block can be determined based on a grant of transmission resources received from the wireless communication network 150. Particularly, transmission resources are allocated for respective streams up to a size of available data units in the respective stream within the limitation of available transmission resources. In other words, for a stream with Bj>0, all available data in the stream can be included in the transport block at S420. In contrast, in the conventional LCP process 300, a logical channel with Bj>0 is served up to a size of the respective Bj.

In some examples, when allocating transmission resources for data units on a logical channel, spaces of the transport block are also assigned for containing a header section associated with a data unit on the logical channel in addition to spaces allocated for containing the data unit itself. For example, a MAC header can be generated at the MAC layer and attached to a MAC SDU received on the logical channel when filling the MAC SDU into the transport block. Thus, spaces used for transmission of a data unit on a logical channel can include a first part for containing the data unit and a second part for containing the respective MAC header in some examples.

In addition, in some examples, spaces of the transport block may be assigned for transmission of other data in addition to data on logical channels. For example, control information generated at MAC layer can be carried in the transport block beside data of logical channels, forming a MAC layer control element as part of the transport block structure. In some examples, the control information can have a higher priority than data on logical channels.

At S430, the variable Bj of the respective stream that is allocated transmission resources is decremented by a size of allocated transmission resources. As a result, the variable Bj can be a negative value.

At S440, remaining transmission resources of the transport block can be allocated to other streams having a variable Bj smaller than zero in a decreasing priority order. The other streams do not include the streams that have been allocated transmission resources at S420. The allocations can be assigned up to a size of available data units in the respective stream within the limitation of available transmission resources. In other words, all available data in one of the other streams can be included in the transport block. The process 400 proceeds to S499, and terminates at S499.

Compared with the LCP mechanism in FIG. 3 example, the data transmission prioritization process 400 can be more efficient and performed faster. For example, each data stream is processed in one step in the process 400, while two steps may need to be performed on one logical channel in the FIG. 3 example. For example, care needs to be taken to determine a boundary that avoids unnecessary segmentation of RLC PDUs between two set of data units in one logical channel that are handled in two separate steps in the FIG. 3 example.

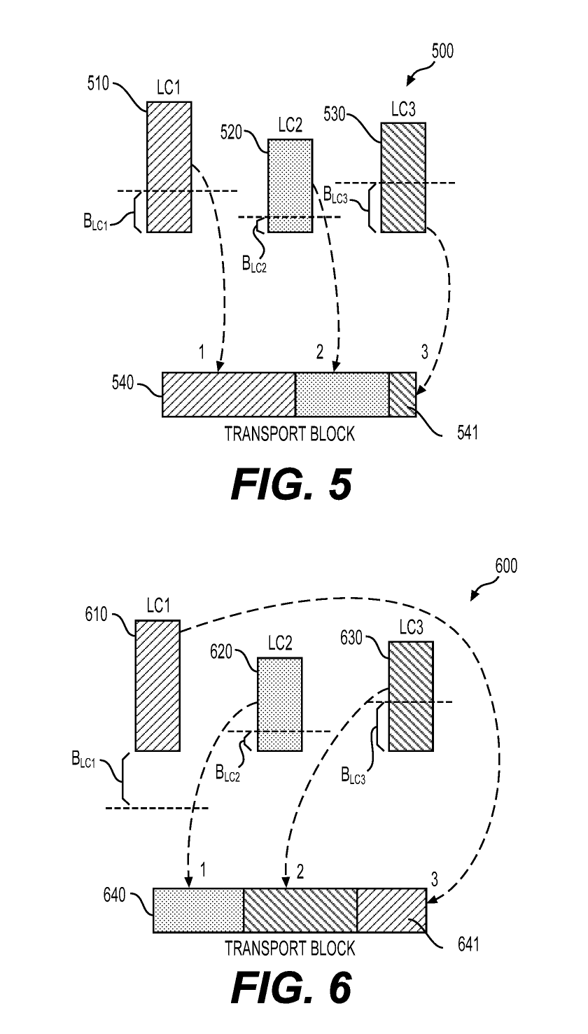

FIG. 5 shows an example LCP process 500 according to an embodiment of the disclosure. The LCP process 500 implements the prioritization scheme presented in the data transmission prioritization process 400. As shown, spaces of a transport block 540 are to be assigned to three logical channels LC1, LC2, and LC3. The three logical channels LC1, LC2, and LC3 are presented in decreasing priority order from left to right. Blocks 510-530 represent available data units of the respective logical channels. Sizes of three available token size variables BLC1, BLC2, and BLC3 are marked on each block 510-530. The variables BLC1, BLC2, and BLC3 have positive values.

During the LCP process 500, transmission resources are allocated to the logical channel LC1 at a first step, and to the logical channel LC2 at a second step. Particularly, all available data in the logical channels LC1 and LC2 are filled into the transport block 540. At a third step, transmission resources are allocated to the logical channel LC3. Particularly, limited by the size of the transport block 540, only remaining spaces 541 are assigned to the logical channel LC3 that is smaller than a size of available data 530 on the logical channel LC3. In this scenario, one RLC PDU in the block 530 is potentially segmented in order to fit the remaining spaces 541 in the transport block 540. Finally, the variables BLC1, BLC2, and BLC3 can be decremented by the amount of resources allocated to the respective logical channels.

FIG. 6 shows another example LCP process 600 according to an embodiment of the disclosure. Similarly, the LCP process 600 implements the priority scheme presented in the data transmission prioritization process 400. As shown, spaces of a transport block 640 are to be assigned to three logical channels LC1, LC2, and LC3. The three logical channels LC1, LC2, and LC3 are presented in decreasing priority order from left to right. Blocks 610-630 represent available data units of the respective logical channels. Sizes of three available token size variables BLC1, BLC2, and BLC3 are marked on each block 610-630. The variable BLC1 is negative, while the variables BLC2, and BLC3 are positive.

During the LCP process 600, transmission resources are first allocated to logical channels with positive variable values. Specifically, transmission resources are allocated to the logical channel LC2 at a first step, and to the logical channel LC3 at a second step. Particularly, all available data in the logical channels LC2 and LC3 are filled into the transport block 640. The variables BLC2, and BLC3 can be decremented by an amount of resources allocated to the respective logical channels LC2 and LC3 subsequently.

After the logical channels with positive variable values are processed, at a third step, transmission resources are allocated to the logical channel LC1 that has a negative variable value. Particularly, limited by the size of the transport block 640, only remaining spaces 641 are assigned to the logical channel LC1 that is smaller than a size of the block 610. In this scenario, one RLC PDU in the block 610 is potentially segmented in order to fit the remaining spaces 641 in the transport block 640.

A disadvantage of the data transmission prioritization processes 400-600 is that latency of data on logical channels can be increased. For example, when a stream of data units, such as a logical channel, is allocated an amount of transmission resources significantly above an available token size of the variable Bj, the probability that the stream of data units would be served in following TTIs correspondingly reduce. In order to counter this latency effect, in one example, a negative limit is introduced on a variable Bj for logical channels with latency requirements. For example, a negative bucket size duration (BSDneg) can be defined for a logical channel. Accordingly, a variable Bj of the respectively logical channel having a PBR can only go down to a minimum of PBR×BSDneg. In other words, for a stream having a variable Bj larger than zero, Bj can be decremented a size of allocated transmission resources up to a minimum of the negative limit . The BSDneg determines the number of TTIs for which a logical channel can go unserved before the Bj becomes positive again.

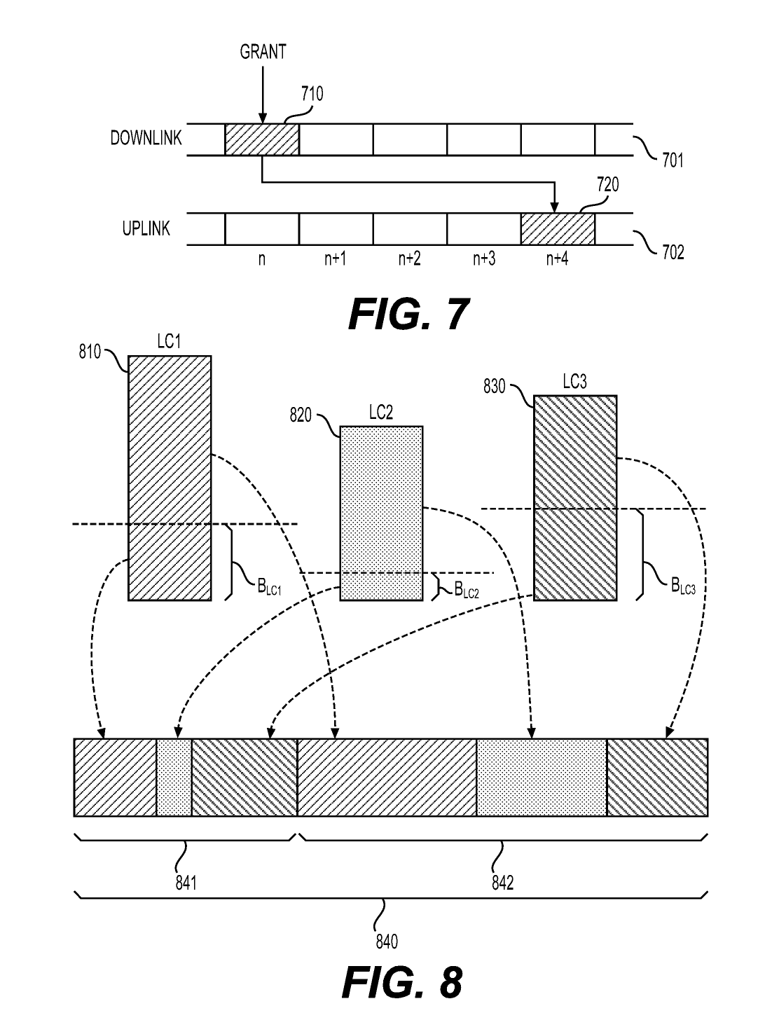

FIG. 7 shows a transmission resource grant timing example. A first sequence of downlink sub-frames 701 and a second sequence of uplink sub-frames 702 are shown in FIG. 7. The two sequences 701 and 702 can be transmitted between a communication device and a base station in an LTE system operating in frequency division duplex (FDD) mode. The sub-frames in the two sequences 701 and 702 can be synchronized.

A sub-frame in the downlink sequence 701 can carry information of an uplink transmission resource grant, also referred to as an uplink scheduling grant. The grant provides the communication device information about assigned physical transmission resources and associated transport format to use for transmission of uplink data during a sub-frame. As shown, a transmission resource grant is carried in a sub-frame 710 in the downlink sequence 701. The grant corresponds to an uplink sub-frame 720 in the unlink sequence 702. The sub-frame 720 is three sub-frames away from the sub-frame 710. Accordingly, after the grant is received at the sub-frame 710, preparation of a transport block can be performed during at least the following three TTIs.

According to the disclosure, in some newly developed communication standards, a time interval between reception of a grant and transmission of a transport block defined by the grant can be reduced significantly. For example, in 5G NR standards, in order to reduce response latency, a TTI corresponding to a sub-frame can be reduced from fourteen OFDM symbols to two OFDM symbols. In another example, an interval between the sub-frame 710 for receiving an uplink grant and the sub-frame 720 for transmitting a respective data block can be configured to be less than three sub-frame, for example, taking a number of 1 or 2 sub-frames. Consequently, the time interval between reception of the grant and transmission of the corresponding transport block may not be long enough for preparation of the transport block.

In order to satisfy the latency requirement in newly developed communication standards, data block preparation can be performed prior to knowledge of a transmission resource grant according to embodiments of the disclosure. For example, a transport block structure (referred to as non-real time data block) can be created at a MAC layer prior to receiving a grant. The transport block structure can then be passed to a PHY layer. Once the grant is received, part or all of the prepared transport block structure can be selected to fit the grant. The prepared structure can be designed in such a way that regardless of a size of a transport block determined by the grant, logical channels in the MAC layer are multiplexed according to their channel priorities and PBRs.

FIG. 8 shows a non-real time data block preparation example according to an embodiment of the disclosure. As shown, data on three logical channels LC1, LC2, and LC3 are organized into a non-real time data block 840 prior to knowledge of a transmission resource grant. The non-real time data block 840 can include two sections 841 and 842. The first section 841 can be positioned at the start of the non-real time data block 840, while the second section 842 can follow the first section. The first section 841 can contain a minimum amount of data needed to maintain a QoS level of each logical channel. The second section 842 can contain the rest of the available data on each logical channel in an order according to each logical channel's priority.

Similarly, each logical channel LC1-LC3 can be configured with a PBR, a priority value, and a variable Bj indicating an available token size. In FIG. 8, the logical channels LC1-LC3 are shown in priority order from left to right. Blocks 810-830 represent a size of available data units contained in each logical channel. In one example, the creation of the non-real time data block 840 can include two steps. At a first step, for logical channels with Bj>0, an amount of data having the size of Bj is filled into the first section 841 of the non-real time data block in decreasing priority order. In addition, the variable Bj can accordingly be decremented. At a second step, the remaining data on each logical channel is filled into the second section 842 in decreasing priority order. As a result, all data on the logical channels LC1-LC3 is organized into the non-real time data block 840, and the non-real time data block 840 has a size equal to the total size of the data on the logical channels LC1-LC3. Alternatively, the non-real time data block 840 can have a size equal to a maximum possible transport block, for example, configured by the network 150.

Prior to reception of a transmission resource grant, the created data block 840 can be transferred to a physical layer entity. In one example, the physical layer entity is implemented with a signal processing circuit on a chip, and the created data block 840 is stored on a memory external to the chip. Transfer of the data block 840 from the external memory to an on-chip memory may take, for example, a time of 10% of a TTI. Thus, by transferring all or part of the data block 840 to an on-chip memory from an external memory in advance of reception a transmission resource grant, processing time of the data block 840 at the physical layer after reception of the grant can be expanded. In addition, in one example, prior to reception of the grant, the PHY layer entity can start to process the data block 840 (e.g., start an encoding process) after the data transfer is completed or while the data transfer is being performed.

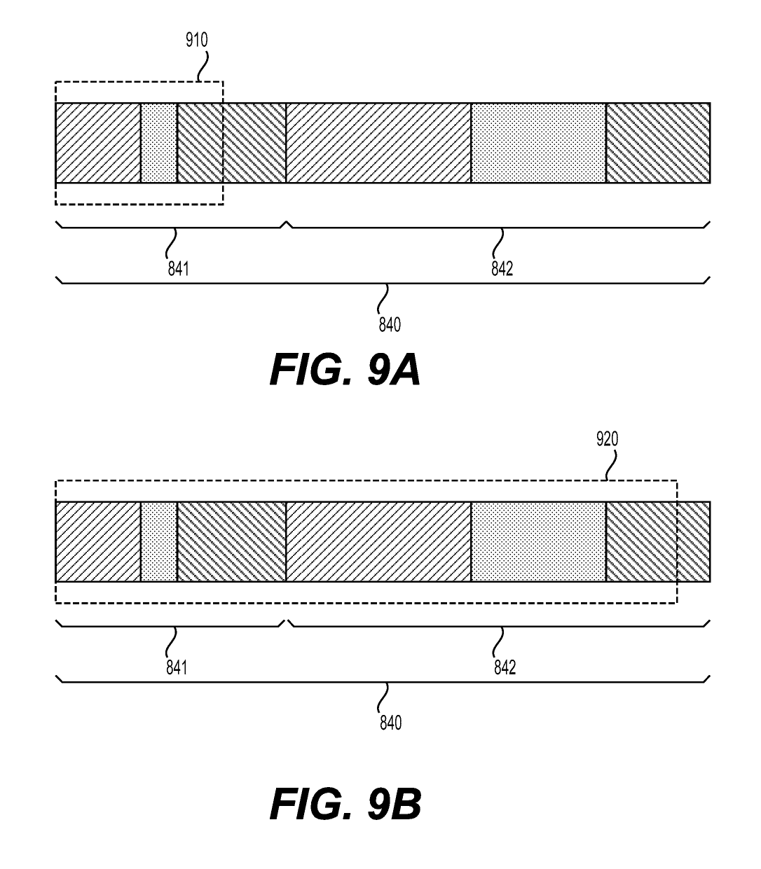

FIGS. 9A and 9B show examples of selecting a portion of a non-real time data block to fit a transport block size according to an embodiment of the disclosure. The non-real time data block 840 in FIG. 8 is used as an example in FIGS. 9A and 9B. The non-real time data block 840 can be stored in a buffer at the physical layer entity and potentially being processed. In FIG. 9A, a small grant is received, and a transport block size 910 represented by a dashed frame is subsequently determined based on the grant. As shown, the transport block size 910 is smaller than the first section 841. Accordingly, a front part of the first section 841 is selected to match the transport block size 910. In FIG. 9B, a large grant is received, and a transport block size 920 represented by a dashed frame is subsequently determined. As shown, the transport block size 920 is larger than a size of the first section 841 but smaller than that of the non-real data block 840. Accordingly, a front part of the non-real data block 840 is selected to match the transport block 920.

In various examples, the selection of a portion of the non-real data block 840 can be performed either at the PHY layer entity or the MAC layer entity. For example, a grant can be received at the physical layer and provided to the MAC layer. The MAC layer can previously keep structure information of the non-real data block. After the grant is received, the MAC layer can accordingly determine the transport block size 910 or 920, and subsequently determine the selected portion of the non-real data block. Size information of the selected portion can then be transmitted to the PHY layer. Alternatively, the PHY layer can conduct the above determination based on the grant.

In one example, the MAC layer keeps the data of each logical channel LC1-LC3 in FIG. 8 in buffers while preparing the non-real data block 840. After the selection of a portion of the non-real data block 840 in FIG. 9A or FIG. 9B, the MAC layer remove selected data from the respective logical channels according to the selection. In addition, the MAC layer adjusts the Bj of respective logical channels according to the selection. For example, an amount of unselected data in the first section 841 in FIG. 9A may be returned back to a previously decremented Bj value. Based on the updated data on the logical channels and the respective variables Bj, a next round of non-real data block preparation can be initiated before a next grant is received.

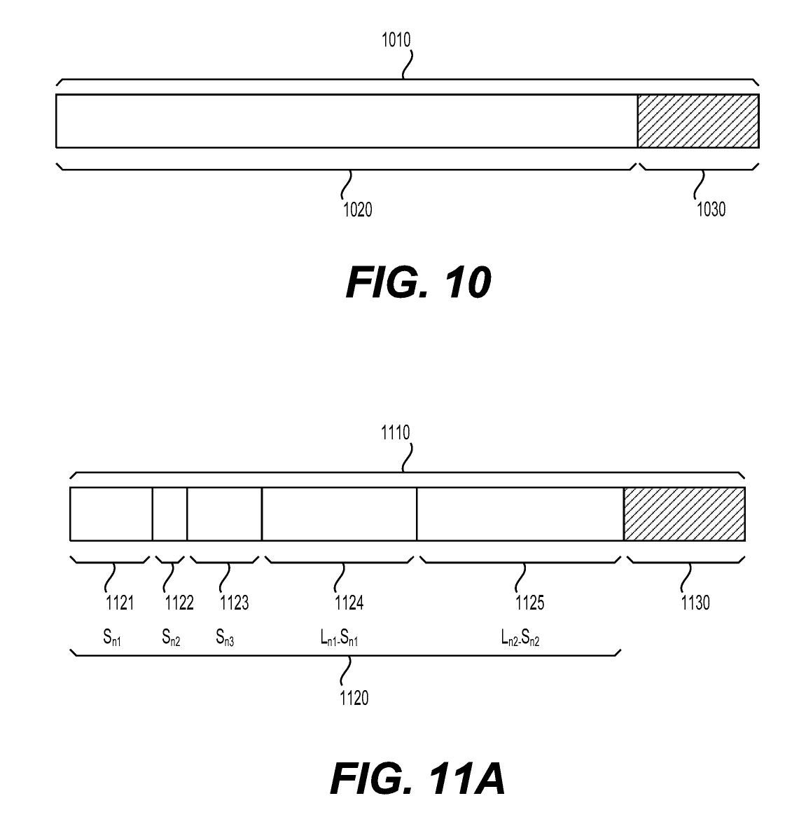

FIG. 10 shows an example of a transport block 1010 according to an embodiment of the disclosure. The transport block 1010 can be created as a result of processes described in the examples of FIG. 8, FIG. 9A and FIG. 9B. However, a section containing real time control information 1030 is added at the rear of the transport block 1010. Another section containing a selected portion of non-real time data block 1020 is positioned at the front of the transport block 1010.

For example, a non-real time data block can be generated at a MAC layer and transferred to a PHY layer prior to knowledge of a grant. While the PHY layer is processing and transmitting the non-real time data block, a grant can be received. The MAC layer can accordingly determine a size of the transport block 1010, a size of the selected portion of non-real block data 1020 that matches the transport block size 1010, and a structure of the control information 1030. Subsequently, the MAC layer can create the control information 1030 and transfer the control information 1030 to the PHY layer. Particularly, the control information 1030 can be positioned at the rear of the transport block 1010 overwriting the tail end of the transport block 1010.

The control information 1030 can describe a structure of the transport block 1010. For example, the control information 1030 may include information about logical channels multiplexed in the transport block 1030, information about boundaries of data blocks within a logical channel, segmentation information (e.g., an entire MAC SDU from a logical channel does not fit into the transport block 1020 and is partially transmitted). In some alternative examples, the control information 1030 is not included in the transport block 1010, and is transmitted separately, for example, through a separate physical channel.

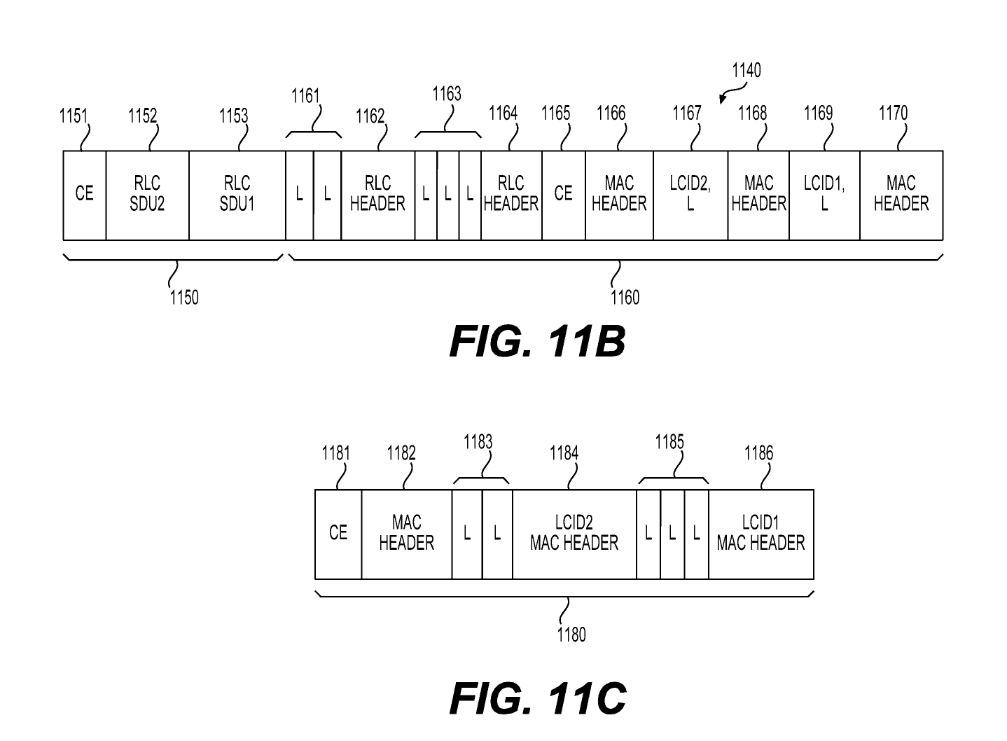

FIGS. 11A-11C shows examples of control information structures according to an embodiment of the disclosure. FIG. 11A shows a transport block 1110 includes a pay load 1120 and control information 1130. The transport block 1110 can be generated based on processes described in the examples of FIG. 8 to FIG. 10. Accordingly, the payload 1120 corresponds to a selected portion of a non-real time data block, while the control information 1130 can be generated after reception of a grant. As shown, the payload 1120 includes minimum data 1121-1123 corresponding to three logical channels n1-n3 and each having a size of Sn1, Sn2, or Sn3. In addition, the payload 1120 includes remaining data 1124 and 1125 corresponding to the logical channels n1-n2. A size of all data from the logical channel n1 is represented as Ln1. Similarly, a size of all data from the logical channel n2 or n3 is represented as Ln2, or Ln3. Accordingly, sizes of the remaining data of the logical channels n1 and n2 are represented as Ln1-Sn1 and Ln2-Sn2, respectively. In alternative examples, due to a size of the transport block 1110, all data from the logical channel n2 may not fit into the transport block.

In one example, the minimum data sizes Sn1-Sn3 is known to the network side. For example, by signaling between the communication device 100 and the network 150 in FIG. 1, the minimum data sizes can be configured in advance by the network 150. In this scenario, the MAC layer only needs to transmit size information of total data of a logical channel carried in the transport block 1110, such as Ln1, Ln2 and Ln3. Positions and sizes of data segments in the payload 1120 can be implicitly understood at the network side. In another example, the minimum data sizes Sn1-Sn3 are unknown to the network side, and have to be included in the control information 1130 and signaled to the network side explicitly.

FIG. 11B shows an example of a transport block 1140 according to an embodiment of the disclosure. The transport block 1140 can be determined based on processes described in the examples of FIG. 8 to FIG. 10. The transport block 1140 includes a payload 1150 and control information 1160. The control information 1160 can be generated after reception of a grant and positioned at the rear end of a transport block 1140. The payload 1150 includes a control element (CE) 1151, and two RLC SDUs 1152 and 1153. The RLC SDU 1152 can include two PDCP PDUs (not shown) concatenated at an RLC layer, while the RLC SDU 1153 can include three PDCP PDUs (not shown) concatenated at the RLC layer.

Following the payload 1150, a first RLC header 1162 and associated PDCP PDU length information 1161 are present. The RLC header 1162 can contain a sequence number of a RLC PDU corresponding to the RLC SDU 1152. The PDCP PDU length information 1161 can include lengths of the respective PDCP PDUs (not shown) in the RLC SDU 1152. Similarly, a second RLC header 1164 and associated PDCP PDU length information 1163 are present, which correspond to the RLC SDU 1153.

A CE flag 1165 and a MAC header 1166 follow the RLC header 1164 and correspond to the CE 1151. Thereafter, a field 1167 including logical channel identification (LCID) and a length of the RLC SDU 1152 is present followed by a MAC header 1168. Similarly, a field 1169 and a MAC header 1170 corresponding to the RLC SDU 1153 are present at the end of the control information 1160. The field 1169 includes logical channel identification (LCID) and a length of the RLC SDU 1153.

FIG. 11C shows an example of control information 1180 according to an embodiment of the disclosure. The control information 1180 can substitute the control information 1160 in the transport block 1140 in FIG. 11B, however, is simplified compared with the control information 1160. Specifically, a CE field 1181 and a MAC header 1182 similar to the CE 1151, CE field 1165 and the MAC header 1166 in FIG. 11B, respectively, are present. Then, two PDCP PDU length fields 1183 including information in the field 1161 in FIG. 11B are present. Thereafter, a MAC header 1184 follows that corresponds to the MAC header 1168, however, may contain LCID information and RLC PDU sequence number corresponding to the RLC SDU 1152 in FIG. 11B. Similarly, three PDCP PDU length fields 1185 including information in the field 1163 in FIG. 11B are present. Following the fields 1185, a MAC header 1186 is present that corresponds to the MAC header 1170, however, may contain LCID information and RLC PDU sequence number corresponding to the RLC SDU 1153 in FIG. 11B.

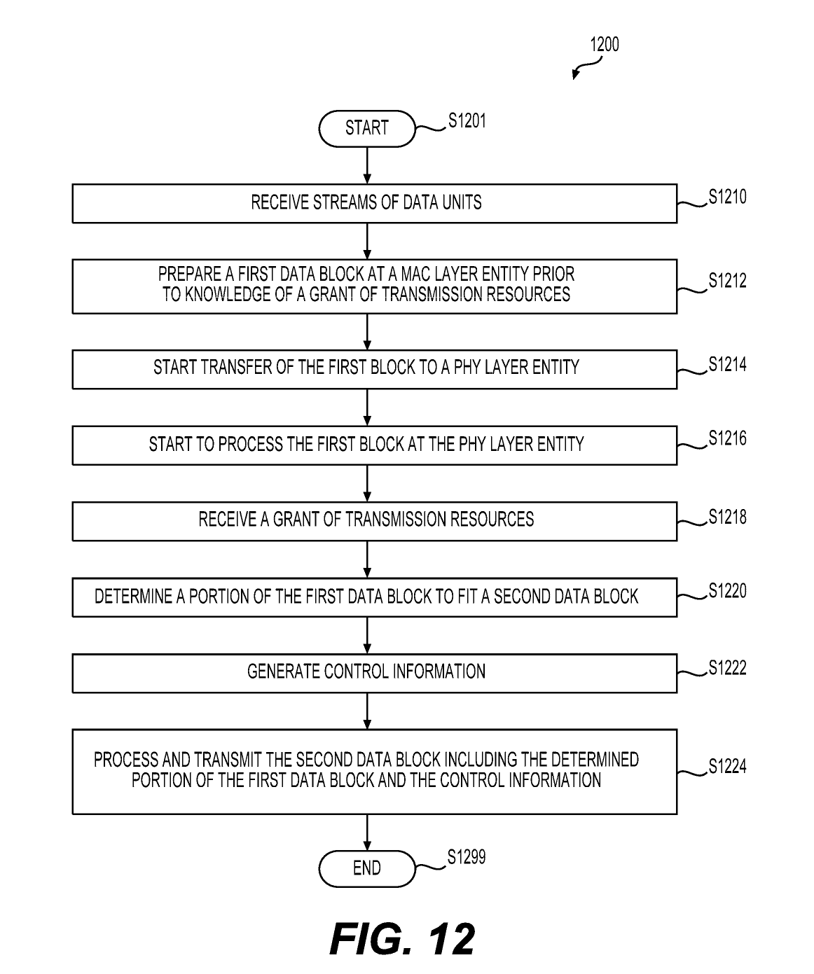

FIG. 12 shows a data block preparation process 1200 according to an embodiment of the disclosure. The data block preparation process 1200 can be performed at the communication device 100 in FIG. 1 example. The data block preparation process 1200 starts at S1201 and proceeds to S1210.

At S1210, multiple streams of data units can be received. For example, RLC SDUs corresponding to different radio bearers can be received at an RLC layer entity. Each RLC SDU can be attached with an RLC header to form an RLC PDU. The RLC PDU can be received on a logical channel of a MAC layer entity. Each logical channel at the MAC layer entity corresponds to a radio bearer.

At S1212, a first data block can be prepared at the MAC layer entity prior to knowledge of a grant of transmission resources. The first data block can be prepared in a way similar to what is described with reference to the example of FIG. 8. For example, a first section in the first data block can include minimum data to satisfy a QoS requirement of each logical channel. A second section in the first data block can contain the remaining data of each logical channel.

At S1214, transfer of all or part of the prepared first data block from the MAC layer entity to a PHY layer entity can be started prior to knowledge of a grant. For example, the prepared first data block can be stored in an off-chip memory, and is subsequently transferred to an on-chip memory.

At S1216, the PHY layer entity can start to process the received first data block. For example, coding process can be initiated to encoding a portion of the first data block.

At S1218, a grant of transmission resources can be received. A size of a second data block, such as a transport block, can be determined based on the received grant.

At S1220, a front part of the first data block can determined to match the second data block. The determined portion of the first data block becomes a payload of the second data block.

At S1222, control information can be accordingly generated at the MAC layer entity after the grant is received and the size of the second data block is determined. The control information can then be transferred to the PHY layer entity and added at the tail end of the second data block. As a result, the second data block including the payload and the control information can be created.

At S1224, the second data block is processed and transmitted at the PHY layer entity. For example, coding and modulation processing can be performed on the second data block. The modulated signals can then be transmitted from the communication device 100 to the wireless communication network 150. The process proceeds to S1299 and terminates at S1299.

While the process 1200 is described as a sequence of steps, in other examples, steps of the process 1200 can be performed in a different order or in parallel. In addition, not all steps of the process 1200 are performed in other examples.

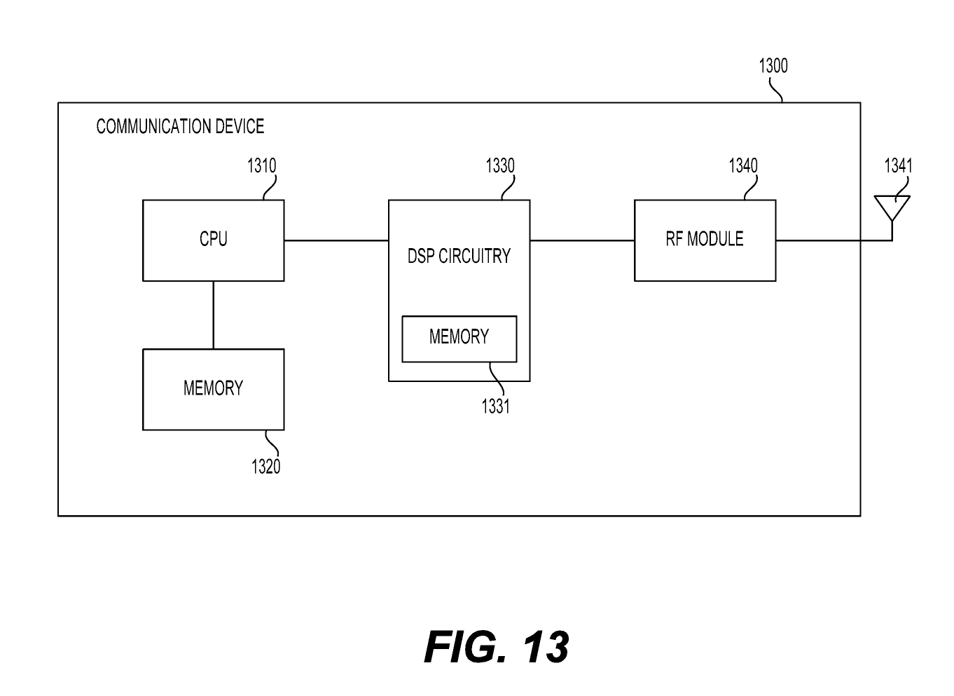

FIG. 13 shows a communication device 1300 according to embodiments of the disclosure. The communication device 1300 can be used for implementation of various embodiments of the disclosure. In different examples, the communication device 1300 can be a mobile phone, a tablet computer, a desktop computer, a vehicle carried device, a utility meter, and the like. The communication device 1300 is capable of communicating with a wireless communication network, such as the network 150 in FIG. 1 example. The communication device 1300 can include a central processing unit (CPU) 1310, a memory 1320, a digital signal processing (DSP) circuitry 1330, and a radio frequency (RF) module 1340. The DSP circuitry 1330 can include a memory 1331.

The CPU 1310 can be configured to perform functions of a PDCP layer entity, a RLC layer entity, or a MAC layer entity in various embodiments by execution of program instructions stored in the memory 1320. For example, the functions and processes for processing data units in a PDCP layer entity, a RLC layer entity, or a MAC layer entity described herein can be performed by the CPU 1310. The memory 1320 can store program instructions that cause the CPU 1310 to perform functions of a PDCP layer entity, a RLC layer entity, or a MAC layer entity. The memory 1320 can include read only memory (ROM), random access memory (RAM), flash memory, a hard disk drive, and the like.

The DSP circuitry 1330 can be configured to perform functions or processes of a PHY layer entity in various embodiments described herein. The functions can include coding, modulation, and the like, that are performed on a transport block. The memory 1331 can be an on-chip memory storing a data block received from a MAC layer, such as a transport block or a data block prepared prior to knowledge of a grant of transmission resources.

The RF module 1340 receives processed data signal from the DSP circuitry 1330 and transmits the signal to a base station in a wireless communication network via an antenna 1341. The RF module 1340 can include a digital to analog convertor (DAC), a frequency up convertor, a filter, and an amplifier for processing and transmission of the received data signal.

The communication device 1300 can optionally include other components, such as input and output devices, additional CPU or signal processing circuitry, and the like. Accordingly, the communication device 1300 may be capable of performing other additional functions, such as executing application programs, and processing alternative communication protocols.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for data transmission prioritization in a communication device, comprising:
receiving multiple streams of data units, each stream of data units having a prioritized bit rate (PBR) for maintaining a quality of service (QoS) level for the respective stream, a priority value, and a variable (Bj) representing a number of bits that are to be prioritized for transmission of data units of the respective stream, wherein the variable (Bj) is incremented for each transmission time interval (TTI) at the respective PBR;
allocating transmission resources to streams having a variable (Bj) larger than zero in an order based on the priority values for transmission of data units during a TTI up to a size of available data units in the respective stream, or a size of available transmission resources, whichever is smaller; and
allocating remaining transmission resources to streams having a variable Bj smaller than zero in an order based on the priority values for transmission data units during the TTI up to a size of available data units in the respective stream, or a size of available transmission resources, whichever is smaller.

2. The method of claim 1, further comprising:
decrementing the variable (Bj) of the respective stream having a variable (Bj) larger than zero by a size of transmission resources allocated to the respective stream.

3. The method of claim 1, wherein each stream is received on a logical channel at a medium access control (MAC) layer of the communication device.

4. The method of claim 1, wherein the transmission resources correspond to available spaces in a data block to be transmitted during the TTI at the communication device.

5. The method of claim 4, further comprising:
filling data units into the data block according to transmission resource allocations to generate the data block; and
processing and transmitting the generated data block.

6. The method of claim 1, wherein one of the streams is further configured with a negative limit for the respective variable (Bj), and the method further includes decrementing the variable (Bj) of the respective stream having a variable (Bj) larger than zero by a size of transmission resources allocated to the respective stream up to a minimum of the negative limit.

7. A non-transitory computer readable medium having computer readable instructions stored thereon which, when executed by a processing circuit, cause the processing circuit to perform a method for data transmission prioritization in a communication device, the method comprising:
receiving multiple streams of data units, each stream of data units having a prioritized bit rate (PBR) for maintaining a quality of service (QoS) level for the respective stream, a priority value, and a variable (Bj) representing a number of bits that are to be prioritized for transmission of data units of the respective stream, wherein the variable (Bj) is incremented for each transmission time interval (TTI) at the respective PBR;
allocating transmission resources to streams having a variable (Bj) larger than zero in an order based on the priority values for transmission of data units during a TTI up to a size of available data units in the respective stream, or a size of available transmission resources, whichever is smaller; and
allocating remaining transmission resources to streams having a variable (Bj) smaller than zero in an order based on the priority values for transmission data units during the TTI up to a size of available data units in the respective stream, or a size of available transmission resources, whichever is smaller.

8. The non-transitory computer readable medium of claim 7, wherein the method further comprises:
decrementing the variable (Bj) of the respective stream having a variable (Bj) larger than zero by a size of transmission resources allocated to the respective stream.

9. The non-transitory computer readable medium of claim 7, wherein each stream is received on a logical channel at a medium access control (MAC) layer of the communication device.

10. The non-transitory computer readable medium of claim 7, wherein the transmission resources correspond to available spaces in a data block to be transmitted during the TTI at the communication device.

11. The non-transitory computer readable medium of claim 10, wherein the method further comprises:
filling data units into the data block according to transmission resource allocations to generate the data block; and
processing and transmitting the generated data block.

12. The non-transitory computer readable medium of claim 7, wherein one of the streams is further configured with a negative limit for the respective variable (Bj), and the method further includes decrementing the variable (Bj) of the respective stream having a variable (Bj) larger than zero by a size of transmission resources allocated to the respective stream up to a minimum of the negative limit.

13. A method for data block preparation prior to knowledge of transmission resources at a communication device, comprising:
receiving streams of data units;
preparing a first data block including data units for transmission in a transmission time interval (TTI) prior to knowledge of transmission resources granted for the TTI;
receiving a grant of transmission resources for the TTI;
determining a portion of the first data block to fit a second data block having a size determined according to the grant of transmission resources for the TTI; and
processing and transmitting the second data block including the determined portion of the first data block.

14. The method of claim 13, further comprising:
Transferring all or part of the first data block from an external memory to an on-chip memory prior to reception of the grant of transmission resources for the TTI.

15. The method of claim 13, further comprising:
starting to process the first data block prior to reception of the grant of transmission resources for the TTI.

16. The method of claim 13, further comprising:
generating control information for the second data block after reception of the grant of transmission resources, the generated control information being included in the second data block.

17. The method of claim 13, wherein each stream of data units is configured with a priority bit rate (PBR) for maintaining a quality of service (QoS) level for the respective stream, and a priority value, and preparing the first data block includes:
filling a first section of the first data block with data units from each stream up to an amount determined by the PBR of each stream; and
filling a second section of the first data block with the rest of data units of each stream in an order based on the priority values,
wherein the determined portion of the first data block to fit the second data block includes a part or all of the first section of the first data block.

18. A communication device, comprising circuitry configured to:
receive streams of data units;
prepare a first data block including data units for transmission in a transmission time interval (TTI) prior to knowledge of transmission resources granted for the TTI;
receive a grant of transmission resources for the TTI;
determine a portion of the first data block to fit a second data block having a size determined according to the grant of transmission resources for the TTI; and
process and transmit the second data block including the determined portion of the first data block.

19. The communication device of claim 18, wherein the circuitry is further configured to:
transfer all or part of the first data block from an external memory to an on-chip memory prior to reception of the grant of transmission resources for the TTI.

20. The communication device of claim 18, wherein the circuitry is further configured to:
start to process the first data block prior to reception of the grant of transmission resources for the TTI.

21. The communication device of claim 18, wherein the circuitry is further configured to:
generate control information for the second data block after reception of the grant of transmission resources, the generated control information being included in the second data block.

22. The communication device of claim 18, wherein each stream of data units is configured with a priority bit rate (PBR) for maintaining a quality of service (QoS) level for the respective stream, and a priority value, and
the circuitry is further configured to:
fill a first section of the first data block with data units from each stream up to an amount determined by the PBR of each stream; and
fill a second section of the first data block with the rest of data units of each stream in an order based on the priority values, p2 wherein the determined portion of the first data block to fit the second data block includes a part or all of the first section of the first data block.
